(19) United States
(12) Patent Application Publication
(10) Pub. No.: US 2016/0198832 A1
(43) Pub. Date: Jul. 14, 2016

(54) METHOD FOR MANUFACTURING NAIL STICKER

(71) Applicant: Dae Seob SO, Daejeon (KR)

(72) Inventor: Dae Seob SO, Daejeon (KR)

(21) Appl. No.: 14/914,502

(22) PCT Filed: Aug. 28, 2014
(86) PCT No.: PCT/KR2014/008017

§ 371 Date: Feb. 25, 2016

(30) Foreign Application Priority Data
Aug. 29, 2013 (KR) 10-2013-0103526

(51) Int. Cl. A45D 29/00; B05D 5/00; B05D 3/00; B05D 7/00

(52) U.S. Cl. CPC A45D 29/001; B05D 7/58; B05D 5/00; B05D 3/007

(57) ABSTRACT

By manufacturing a nail Sticker with the steps of applying a first coating solution including a mixture of alkyl-methacrylate, hydroxyl methacrylate, and solvent, and a nitrocellulose on the base substrate, heat-treating the product, additionally applying a second coating solution that a nitrocellulose solution dissolved in solvent and a thermoplastic resin gel are mixed and stirred, and heat-treating the product, a nail sticker can be provided, which can be easily-attached to the nail, preserved for a long time, and the remaining portion of which can be easily removed.

### TECHNOLOGY

The present invention relates to a method for manufacturing a nail sticker, and in more detail, relates to a method for manufacturing a nail sticker which can be easily attachable and detachable to the fingernails or toenails.

### BACKGROUND ART

A molding apparatus for manicure film is disclosed in Patent Document 1, and Patent Document 2 discloses a structure, a manufacturing method and an attaching method of a nail sticker.

Recently, the users who want to express beauty and individuality are increasing with growing interest regarding beauty treatment.

However, operations of applying the manicure and polishing nails take long time, the users who are unfamiliar with these operations need much longer time, and it is difficult to produce a desired aesthetic.

In order to solve this problem, a nail decorating means of sticker-style disclosed in Patent Document 2 is also suggested.

However, the nail decorating means disclosed in Patent Document 2 had the inconvenience of applying a solvent and attaching a sticker on a nail part.

On the other hand, it is possible to comprise an adhesive layer on one side of a color layer expressing an esthetic sense, however, if the adhesive layer is provided in this way, it is necessary to ensure flexibility of the sticker itself which includes an adhesive layer and a color layer in order that the color layer is attached naturally along the curved surface of the nail.

In order to ensure flexibility in this way, a content of the solvent that make up the color layer and etc. should be more than a predetermined level, however in this case, there is a high possibility that various printing patterns or the color layer itself can be damaged in the process of cutting the nail-shaped sticker.

Furthermore, since a respective sealing means is necessary, there are problems that manufacturing costs rise up and the product cannot be preserved for a long time after it is opened.

### Prior Art Document

KR 1988-0013498 A1, KR 2011-0050908 A1

### DETAILED DESCRIPTION OF THE INVENTION

### Technical Problem

One aspect of the present invention conceived to solve the above problems is intended to provide a method for manufacturing a nail sticker that can be attached to the nail without applying a separate solvent on the nail and be preserved for a long time without a sealing means.

In addition, another aspect of the present invention is intended to provide a method for manufacturing a nail sticker that the remaining portion of the nail sticker can be easily removed.

### Technical Solution

In order to achieve the above purposes, a method for manufacturing a nail sticker according to one embodiment of the present invention comprises (A) applying a first coating solution including a 30˜50 wt % mixture of alkyl-methacrylate, hydroxyl methacrylate, and solvent, and a 50˜70 wt % nitrocellulose on the base substrate; (B) heat-treating the product of the (A) step; (C) applying a second coating solution that a nitrocellulose solution dissolved in solvent and a thermoplastic resin gel are mixed and stirred in a weight ratio of 2.3˜3:1 on a surface of the product of the (B) step; (D) heat-treating the product of the (C) step.

At this time, a content of the hydroxyl methacrylate can be determined in the range of 0.05 to 0.3 times of weight of the alkyl-methacrylate, and a content of the solvent can be determined in the range of 0.02 to 0.9 times of weight of the alkyl-methacrylate.

In addition, in the (B) step, the heat-treatment can be carried out based on a temperature of 40˜50° C. for 1.5˜2.5 minutes, and in the (D) step, the heat-treatment can be carried out based on a temperature of 40˜50° C. for 12˜13 minutes.

In addition, the first coating solution can include an initiator having weight of 0.0002 to 0.1 times by weight of the alkyl-methacrylate and a reinforcing member having weight of 0.001 to 0.1 times by weight of the alkyl-methacrylate, the initiator comprising at least one material selected from benzoyl peroxide and azobisisobutyronitrile, and the reinforcing member comprising at least one material selected from acrylonitrile, methacrylamide, N-methyl acrylamide, styrene, methyl styrene, vinyl toluene, glycidyl methacrylate, monomer including a hydroxyl group such as vinyl acetate, 2-hydroxyethyl-methacrylate, 2-hydroxypropyl-methacrylate, 4-hydroxybutyl-methacrylate, 2-hydroxy ethylene glycol-methacrylate, 2-hydroxy propylene glycol-methacrylate and etc., or acrylic acid, methacrylic acid, acrylic acid dimer, itaconic acid, maleic acid, and maleic anhydride.

In addition, a 0.1 to 20 wt % tolylene diisocyanate adduct of isocyanate trimethylolpropane (TDI-1) based on the total weight of the first coating solution can be added to the first coating solution.

In addition, the thermoplastic resin gel can include a thermoplastic resin of at least one material selected from polyurethane, polyvinyl acetate, ethylene vinyl acetate, and polyvinyl chloride resin, and a plasticizer of at least one material selected from dipropylene glycol dibenzoate (DP) and diethylene glycol dibenzoate (DE).

In addition, the method according to the present invention can further comprise (E) forming a decorative pattern on the surface of the product of the (D) step; and (F) forming a protective layer on the surface of the product of the (E) step.

### Advantageous Effects

An exemplary method for manufacturing a nail sticker according to the embodiment of the present invention provides a beneficial effect that can be attached to the nail without applying a separate solvent on the nail and be preserved for a long time without a sealing means.

Further, regarding the nail sticker manufactured according to an embodiment of the present invention, the user can easily remove the remaining portion of the nail sticker by hand without any additional tool such as a cutter or the bumper when the sticker is attached to the nail.

Furthermore, exemplary method for manufacturing a nail sticker according to the embodiment of the present invention provides a beneficial effect that a nail sticker can be manufactured, which is resistant to external stimuli due to high surface hardness.

### BRIEF DESCRIPTION OF DRAWINGS

FIG. 1 is a cross-sectional view that schematically illustrates a nail sticker manufactured by the manufacturing method according to one embodiment of the present invention.

FIG. 2 is a flow chart that schematically illustrates a nail sticker manufacturing method according to one embodiment of the present invention.

### THE PREFERRED EMBODIMENTS ACCORDING TO THE PRESENT INVENTION

Advantages and features of the present invention, and such techniques for accomplishing the same are clearly understood in reference to the embodiment which is described below in detail with the accompanying figures. However, the present invention may not be limited to the embodiments set forth herein and be implemented as many different and various forms. The present embodiments can be provided in order to complete the disclosure of the present invention and indicate to a person of ordinary skill in the art to complete the scope of the invention. Same reference numerals refers to same elements throughout the whole specification.

The terms used herein are intended to illustrate the embodiments, but not intended to limit the invention. In this specification, the singular forms also include the plural forms unless stated specifically in the text. The terms of “comprise” and/or “comprising” in the specification do not exclude addition or existence of one or more other components, steps, operation and/or elements in addition to the stated components, steps, operation and/or elements.

Hereinafter, with reference to the accompanying drawings, the structures, operations and effects of the present invention will be described in more detail.

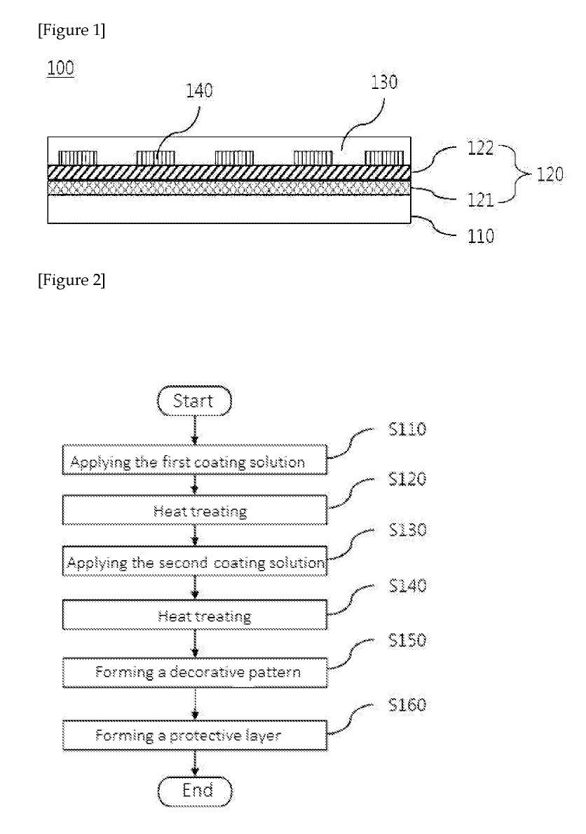

FIG. 1 is an exemplary sectional view that schematically illustrate the nail sticker 100 manufactured in accordance with the embodiment of the present invention, and FIG. 2 is a flow chart that schematically illustrates a nail sticker 100 manufacturing method according to one embodiment of the present invention.

Referring to FIG. 1, the nail sticker according to an embodiment of the present invention includes a composite manicure layer 120. The composite manicure layer 120 includes the first coating layer 121 and the second coating layer 122, and can be implemented on the base substrate 110 for the purpose of improving manufacturing efficiency and convenience of storage. Also, when attaching a nail sticker 100 on the nail or the like, the composite manicure layer 120 can be contacted with the nail in the state of removing the base substrate 110.

On the other hand, in another embodiment, the decorative patterns 140, or the protective layer 130 may be further provided on the top surface of the composite manicure layer 120.

In case of referring FIGS. 1 and 2, a method for manufacturing the nail sticker according to an embodiment of the present invention can includes the steps of applying a first coating solution (S110), heat treatment (S120), applying a second coating solution (S130), heat treatment (S140). Also, the method may further include the steps of forming a decorative pattern (S150) or, forming a protective layer forming (S160), if necessary.

In one embodiment, various kinds of paper or film of synthetic resins and the like can be used as the base substrate 110.

In addition, in order that the composite manicure layer 120 is separated easily from the base substrate 110 to improve user convenience, the first coating solution can be applied in case a release surface on the base substrate 110 is provided.

First, in the step of applying the first coating solution, the first coating solution is applied as a predetermined thickness on the base substrate 110 (S110).

In one embodiment, the first coating solution may comprise an adhesive and nitrocellulose. Herein, a variety of adhesives that are already widely used can be applied as the adhesive, however, according to an embodiment of the present invention, a hollow-stirred material with the addition of polybutene multi-wax to acrylic acid can be used as the adhesive.

In addition, the adhesive according to one embodiment may comprise alkyl-methacrylate of acrylic monomer, and further comprise hydroxy-methacrylate and hydroxyethyl acrylate to improve the flexibility of the adhesive.

Herein, in case that a carbon number of alkyl group of alkyl-methacrylate exceeds 12, the cohesive strength of the adhesive is lowered excessively, therefore the alkyl-methacrylate has an alkyl group having a carbon number of 1 to 12. Further, at least one material can be used as a methacrylate having an alkyl group of a carbon number of 1 to 8, which selected from butyl-methacrylate, 2-ethylhexyl-methacrylate, ethyl-methacrylate, methyl-methacrylate, n-propyl-methacrylate, isopropyl-methacrylate, t-butyl-methacrylate, pentyl-methacrylate, n-octyl-methacrylate, isooctyl-methacrylate and isononyl-methacrylate.

On the other hand, if the hydroxy-methacrylate is included too little, the flexibility of the adhesive becomes too low and initial adhesive force is insufficient, and if it is included excessively, a cohesive strength is lowered due to the excessive flexibility of the adhesive and the adhesion durability is lowered. Therefore, the hydroxy methacrylate is preferably included in a range of 0.05 to 0.3 times of the weight of the alkyl-methacrylate.

In one embodiment, a solvent may be used to copolymerize alkyl-methacrylate and hydroxy methacrylate, at least one material selected from acetone, methyl ethyl ketone, toluene, and ethyl acetate may be used as the solvent. At this time, if the amount of the solvent is too little, applying process become difficult, and if the amount of the solvent is too much, a cohesive strength is lowered, therefore, the amount of solvent is preferably included in a range of 0.02 to 0.9 times of the weight of the alkyl-methacrylate.

In another embodiment, an initiator may be used in order to improve the copolymerization efficiency of alkyl-methacrylate and hydroxy methacrylate, and as the initiator, benzoyl peroxide and/or azobisisobutyronitrile (AIBN) can be used. At this time, if the amount of initiator is too little, a yield of copolymerized product is lowered excessively, if the amount of initiator is too much, the copolymerization reaction proceeds abruptly so that the molecular weight of the copolymerized product is increased excessively, therefore, the amount of initiator is preferably included in a range of 0.0002 to 0.1 times of the weight of the alkyl-methacrylate.

Furthermore, according to an embodiment of the present invention, when producing the acrylic copolymer, Monomers containing crosslinkable functional groups, mainly vinyl monomers and an acrylic monomers can be used additionally in order to adjust the glass transition temperature of the adhesive or assign other features and characteristics, and a preferred monomer for this can be used with only one, or two or more kinds among acrylonitrile, methacrylamide, N-methyl acrylamide, styrene, methyl styrene, vinyl toluene, glycidyl-methacrylate, or vinyl acetate and the like. The Monomers containing crosslinkable functional groups are reacted with crosslinking agent, and impart a cohesive or adhesive strength due to chemical bond not to cause cohesive destruction of the adhesive at a high temperature or humidity condition.

In addition, monomer including a hydroxyl group such as 2-hydroxyethyl-methacrylate, 2-hydroxypropyl-methacrylate, 4-hydroxybutyl-methacrylate, 2-hydroxy ethylene glycol-methacrylate, 2-hydroxy propylene glycol-methacrylate and etc., or acrylic acid, methacrylic acid, acrylic acid dimer, itaconic acid, maleic acid, and maleic anhydride are indicated as examples of Monomers containing crosslinkable functional groups, however, not limited to these materials, and the Monomers can be used with only one, or two or more kinds.

The content of the reinforcing member is preferably included in a range of 0.001 to 0.1 times of the weight of the alkyl-methacrylate. If the content of the reinforcing member is too little, it is easy to cause cohesive destruction of the adhesive at a high temperature or humidity condition and to reduce adhesive strength, if the content of the reinforcing member is too much, the surface deformation happens seriously by reducing adhesive consistency, and the cohesive force is increased in relation to reduction of the characteristics of flexibility so that the relaxation ability of the cohesive force is lowered.

The first coating solution can be implemented by mixing the above adhesive with nitrocellulose.

*On the other hand, if the content of the adhesive is less than 30 wt % based on the total weight of the first coating solution, adhesive bonding strength is lowered and if the content of the adhesive is more than 50 wt % based on the total weight of the first coating solution, the surface hardness and waterproof adhesion are lowered.

In one embodiment, the first coating solution includes nitrocellulose, and the nitrocellulose performs a function of improving the surface durability of the nail sticker.

On the other hand, if the content of the nitrocellulose is less than 50 wt % based on the total weight of the first coating solution, the surface hardness is excessively lowered, and if the content of the nitrocellulose is more than 70 wt % based on the total weight of the first coating solution, the flexibility of the nail sticker is lowered. Therefore, the content of the nitrocellulose is preferably included in a range of 10 to 80 wt % based on the total weight of the first coating solution.

In one embodiment, the first coating solution may comprise a multi-functional crosslinking agent in order to perform the crosslinking role. At this time, tolylene diisocyanate adduct of isocyanate trimethylolpropane (TDI-1) can be selected as the multi-functional crosslinking agent.

Further, if the multi-functional crosslinking agent is too little, adhesion and bonding strength of the first coating solution is lowered, and if the multi-functional crosslinking agent is too much, the stability of the first coating solution is declined, therefore, the multi-functional crosslinking agent is preferably included in a range of 0.1 to 20 wt % based on the total weight of the first coating solution.

On the other hand, in one embodiment, the silane-based cross-linking agent such as 3-glycidoxypropyltrimethoxysilane can be further added.

Accordingly, the first coating solution that durability, consistency with nitrocellulose, adhesion with the nails, and thermal stability are improved can be implemented.

According to one embodiment of the present invention, the heat treatment step (S120) may be performed in case that the first coating solution is applied to the base substrate 110.

At this time, the heat treatment step (S120) may be performed for 1.5 to 2.5 minutes based on the temperature of 40˜50° C.

The first coating layer 121 may be formed by performing such a heat treatment step (S120).

Next, it is performed to apply a second coating solution on the first coating layer 121 (S130).

In one embodiment, the second coating solution may be a material that thermoplastic resin gel and nitrocellulose are mixed and stirred as mentioned above.

On the other hand, a mixture of nitrocellulose and a solvent is called a stock solution of manicure. When the mixture of nitrocellulose and the solvent is called the stock solution of manicure as above, the second coating solution may be a material that a thermoplastic resin gel and a stock solution of manicure are mixed and stirred in a weight ratio of 1:2.3˜3.

In one embodiment, the thermoplastic resin gel may be a material that a thermoplastic resin is mixed and stirred with a plasticizer. At this time, polyurethane, polyvinyl acetate, ethylene vinyl acetate, polyvinyl chloride resin may be used as the thermoplastic resin. In addition, a non-phthalate plasticizer may be used as the plasticizer. A non-phthalate plasticizer is environment-friendly and human-friendly not to use conventional phthalate plasticizer that has a problem of releasing environmental hormones, improves the efficiency of task to require flowability to use the thermoplastic resin together, and also improves flexibility of the second coating solution. At this time, dipropylene glycol dibenzoate (DP), diethylene glycol dibenzoate (DE), or a mixture (benzoplex) of these components at a predetermined ratio, and etc. can be used as the non-phthalate plasticizer. As such a plasticizer is contained at a suitable amount, flowability, viscosity, adhesion at low temperature, film forming property at low temperature and flexibility of the second coating solution can be improved, and the content of the plasticizer is preferably determined in the range of 0.01 to 0.2 times of weight of the thermoplastic resin.

According to one embodiment, the heat treatment step (S140) may be performed in case the second coating solution is applied on the first coating layer 121. At this time, the heat treatment step (S140) may be performed for 12 to 13 minutes based on the temperature of 40˜50° C. By performing such a heat treatment step (S140), the second coating layer 122 may be formed.

On the other hand, a composite manicure layer 120 refers to the combined layer of the first coating layer 121 and the second coating layer 122.

*When users apply the composite manicure layer 120 on the nails, the composite manicure layer 120 can be fixed on the nails by separating the composite manicure layer 120 from the base substrate 110, locating only the composite manicure layer 120 on the nails, and pressing it with a suitable pressure.

On the other hand, in one embodiment, the composite manicure layer 120 may be formed of at least one color selected from various colors.

Next, a step (S150) of forming a decorative pattern layer can be performed, that a decorative pattern 140 is formed on the composite manicure layer 120, in other words, a top surface of the second coating layer 122. At this time, the decorative pattern 140 may be formed of a variety of patterns formed in a same or different color with the composite manicure layer. FIG. 1 illustrates an example that this pattern is implemented as a shape of the decorative pattern 140 that is formed to protrude from the composite manicure layer 120, but not limited to this. In addition, the decorative patterns 140 may be formed by using a printing method such as known in the art.

Next, a step (S160) of forming a protective layer can be performed, which develops the protective layer 130. The protective layer 130 may improve gloss effect of the composite manicure layer 120, at the same time, the composite manicure layer 120 and the decorative pattern 140 can be protected from external impact by the protective layer 130 (S160).

After all of the above steps are carried out, it may be cut so as to become a suitable size and shape in consideration of the size of the attached object.

When the adhesive is contained much more than the range mentioned above, it may be a problem that the nail sticker 100 can be pushed easily by the external force in case it is attached to the nail. Conversely, when it is contained too little, it may be a problem that the nail stickers 100 is not easily attached to the nails and easily separated from the nails.

If the above-mentioned heat treatment steps (S120, S140) are performed at a higher temperature, the time required for heat treatment can be shortened. However, if they are performed at too high a temperature, bubbles may be generated on the composite layer nail 120.

In addition, by performing the above-mentioned heat treatment steps, the content of the acetone from the composite layer nail 120 may be less than 15 wt %.

Accordingly, the nail sticker 100 according to one embodiment of the present invention can be easily attached to fingernails or the like without applying a separate solvent on the fingernails or the like.

In addition, the nail sticker 100 can be preserved and used for a long time without a separate sealing means.

Further, as described above, the first coating solution which is used in the process of manufacturing the nail sticker according to one embodiment of the present invention, includes a copolymer of alkyl methacrylate and hydroxy methacrylate. In this case, in consideration of engaging force, engaging portion between the alkyl-methacrylate and the hydroxy methacrylate is weaker than engaging portion of couple of the alkyl-methacrylate or couple of the hydroxy methacrylate. If the acrylic copolymer is made of a single material, when pulling the nail sticker by hand, the nail sticker become stretched and cut off, however, as shown in the embodiment of the invention, if the nail sticker includes engagement of alkyl methacrylate and hydroxy methacrylate, its predetermined part may be cut off without stretch even when it is pulled by hand. Herein, when forming a boundary in a manner of rubbing and folding before pulling the nail sticker, it is smoothly cut off along a boundary when pulling out the nail sticker.

Therefore, in a state the nail sticker is attached to the nails or the like, when removing the part beyond the scope of the nails, the extra nail stickers can be removed by the simple method of pulling the part to be removed after forming a boundary by folding a boundary to be removed by hand. In order to remove the extra nail stickers in a state the nail sticker is attached to the nails, tools such as bumper or cutter, etc. were used conventionally, however, according to an embodiment of the present invention, the extra nail stickers can be removed without such tools.

In addition, a problem may be solved that the composite layer nail 120 sticks to the cutting blade in the process of cutting the composite layer nail after forming the composite layer nail 120.

Moreover, the nail sticker 100 in accordance with an embodiment of the present invention can be easily removed from the nail when it is kept immersed in warm water of 50˜60° C. for predetermined time in case of being attached to the nails. Accordingly, the inconvenience of using a separate solvent such as acetone may be reduced in order to remove the manicure. Also, if only an adhesive is used, the situation that the nail sticker is pushed on the nails happens, if the sticker is removed, an adhesive material remains on the nail and is removed by additional efforts, however, by the nail sticker 100 of the present invention in accordance with one embodiment, these problems can be solved.

In addition, since the extra nail stickers 100 deviated from the nails can be removed by being folded downwardly and pulled out in a state that the nail stickers 100 longer than the nails is attached to the nail, an inconvenience of cutting the extra nail stickers 100 can be solved.

### Example 1

In the synthetic Example 1, the first coating solution is manufactured by mixing and stirring for 3 hours, 65 wt % of solid content of the acrylic copolymer composition, 34.5 wt % of a nitrocellulose resin, 0.3 wt % of the multifunctional crosslinking agent of tolylene diisocyanate adduct of isocyanate trimethylolpropane (TDI-1), and 0.2 wt % of silane-based crosslinking agent of 3-glycidoxypropyltrimethoxysilane.

Further, a specimen is formed by knife-coating the first coating solution to a release paper (100*100 mm), heat-treating on a temperature of 40 to 50° C., coating the second coating solution, and heat-treating.

### Example 2

In the synthetic Example 2, the first coating solution is manufactured by mixing and stirring for 3 hours, 70 wt % of solid content of the acrylic copolymer composition, 29.5 wt % of a nitrocellulose resin, 0.3 wt % of the multifunctional crosslinking agent of tolylene diisocyanate adduct of isocyanate trimethylolpropane (TDI-1), and 0.2 wt % of silane-based crosslinking agent of 3-glycidoxypropyltrimethoxysilane.

Further, a specimen is formed by knife-coating the first coating solution to a release paper (100*100 mm), heat-treating on a temperature of 40 to 50° C., coating the second coating solution, and heat-treating.

### Example 3

In the synthetic Example 3, the first coating solution is manufactured by mixing and stirring for 3 hours, 75 wt % of solid content of the acrylic copolymer composition, 24.5 wt % of a nitrocellulose resin, 0.3 wt % of the multifunctional crosslinking agent of tolylene diisocyanate adduct of isocyanate trimethylolpropane (TDI-1), and 0.2 wt % of silane-based crosslinking agent of 3-glycidoxypropyltrimethoxysilane.

Further, a specimen is formed by knife-coating the first coating solution to a release paper (100*100 mm), heat-treating on a temperature of 40 to 50° C., coating the second coating solution, and heat-treating.

### Comparative Example 1

1. A composition dissolved by mixing and stirring 50 wt % of acetone and 10 wt % of butyl acetate with 26 wt % of a vinyl chloride resin is provided.

2. A specimen is formed by second-coating nitrocellulose and drying after first-coating the composition manufactured in the above 1

### Experimental Example 1

Wet and heat resisting properties, heat resisting properties, and heat resisting adhesion of the specimen manufactured by the Examples 1 to 3, and the Comparative Example 1 are measured and the result are shown in Table 1.

Herein, the wet and heat resisting properties are measured by observing whether bubble or peeling has occurred after holding the specimen for 72 hours at 90% of a relative humidity and 60° C. of the temperature, the heat resisting properties are measured by observing whether bubble or peeling has occurred after holding the specimen for 72 hours at 80° C. of the temperature and heat resisting adhesion is illustrated as adhesion (kg f/cm²) measured by using a universal testing machine.

* Evaluation standard

∘: No bubble or peeling phenomenon.

Δ: bubbles or peeling phenomenon exist slightly.

x: bubbles or peeling phenomenon exist.

TABLE 1

| | wet and heat | | |
|---|---|---|---|
| | resisting | heat resisting | heat resisting adhesion |
| Division | properties | properties | (gf/cm³) |
| Example 1 | ∘ | ∘ | 1230 |
| Example 2 | ∘ | ∘ | 1260 |
| Example 3 | ∘ | ∘ | 1310 |
| Experimental | Δ | ∘ | 1050 |
| Example 1 | | | |

In the above Table 1, the wet and heat resisting properties, heat resisting properties, and heat resisting adhesion of the specimen of the Examples 1 to 3 are more excellent compared to those of the specimen according to Comparative Example 1.

### DESCRIPTION OF THE REFERENCE NUMBER

100: nail Sticker
110: base substrate
120: composite manicure layer
121: first coating layer
122: second coating layer
130: protective layer
140: decorative pattern

### INDUSTRIAL APPLICABILITY

The invention can be utilized in the cosmetic field, such as decorating a fingernail or toenail. In other words, the method for manufacturing a nail sticker according to one embodiment of the present invention can be utilized to manufacture the nail sticker for the decoration of human fingernails or toenails.

1. A method for manufacturing a nail Sticker, comprising;
(A) applying a first coating solution including a 30˜50 wt % mixture of alkyl-methacrylate, hydroxyl methacrylate, and solvent, and a 50˜70 wt % nitrocellulose on the base substrate;
(B) heat-treating the product of the (A) step;
(C) applying a second coating solution that a nitrocellulose solution dissolved in solvent and a thermoplastic resin gel are mixed and stirred in a weight ratio of 2.3˜3:1 on a surface of the product of the (B) step;
(D) heat-treating the product of the (C) step.

2. The method according to claim 1,
wherein a content of the hydroxyl methacrylate is determined in the range of 0.05 to 0.3 times of weight of the alkyl-methacrylate, and
a content of the solvent is determined in the range of 0.02 to 0.9 times of weight of the alkyl-methacrylate.

3. The method according to claim 1,
wherein the (B) step is characterized in that the heat-treatment is carried out based on a temperature of 40˜50° C. for 1.5˜2.5 minutes.

4. The method according to claim 1 or claim 3,
wherein the (D) step is characterized in that the heat-treatment is carried out based on a temperature of 40˜50° C. for 12˜13 minutes.

5. The method according to claim 1,
wherein the first coating solution includes an initiator having weight of 0.0002 to 0.1 times by weight of the alkyl-methacrylate and a reinforcing member having weight of 0.001 to 0.1 times by weight of the alkyl-methacrylate,
the initiator comprising at least one material selected from benzoyl peroxide and azobisisobutyronitrile, and
the reinforcing member comprising at least one material selected from acrylonitrile, methacrylamide, N-methyl acrylamide, styrene, methyl styrene, vinyl toluene, glycidyl methacrylate, vinyl acetate, monomer including a hydroxyl group such as 2-hydroxyethyl-methacrylate, 2-hydroxypropyl-methacrylate, 4-hydroxybutyl-methacrylate, 2-hydroxy ethylene glycol-methacrylate, 2-hydroxy propylene glycol-methacrylate and etc., or acrylic acid, methacrylic acid, acrylic acid dimer, itaconic acid, maleic acid, and maleic anhydride.

6. The method according to claim 1,
wherein a 0.1 to 20 wt % tolylene diisocyanate adduct of isocyanate trimethylolpropane (TDI-1) based on the total weight of the first coating solution is added to the first coating solution.

7. The method according to claim 1,
wherein the thermoplastic resin gel includes a thermoplastic resin of at least one material selected from polyurethane, polyvinyl acetate, ethylene vinyl acetate, and polyvinyl chloride resin, and a plasticizer of at least one material selected from dipropylene glycol dibenzoate (DP) and diethylene glycol dibenzoate (DE).

8. The method according to claim 1, further comprising;
(E) forming a decorative pattern on the surface of the product of the (D) step; and
(F) forming a protective layer on the surface of the product of the (E) step.
